(19) United States
(12) Patent Application Publication
(10) Pub. No.: US 2022/0277360 A1
(43) Pub. Date: Sep. 1, 2022

(54) AN INTENT SYSTEM AND METHOD OF DETERMINING INTENT IN A PROCESS JOURNEY

(71) Applicant: THUNDERHEAD (ONE) LIMITED, London (GB)

(72) Inventor: Ray GERBER, London (GB)

(73) Assignee: THUNDERHEAD (ONE) LIMITED, London (GB)

(21) Appl. No.: 17/629,859

(22) PCT Filed: Jul. 24, 2020
(86) PCT No.: PCT/GB2020/051794

§ 371 Date: Jan. 25, 2022

(30) Foreign Application Priority Data
Jul. 25, 2019 (GB) 1910672.3

(51) Int. Cl. G06Q 30/02; G06Q 10/06

(52) U.S. Cl. CPC G06Q 30/0281; G06Q 10/0633; G06Q 10/0637

(57) ABSTRACT

A method of determining intent base upon initially flattening interactions using set alphanumeric identifiers into sequences then defining From targets and To targets at least to determine sequence journeys between such targets and possibly Through/Not through targets such that for use From and To targets as fragments of sequences provide a prediction of an outcome.

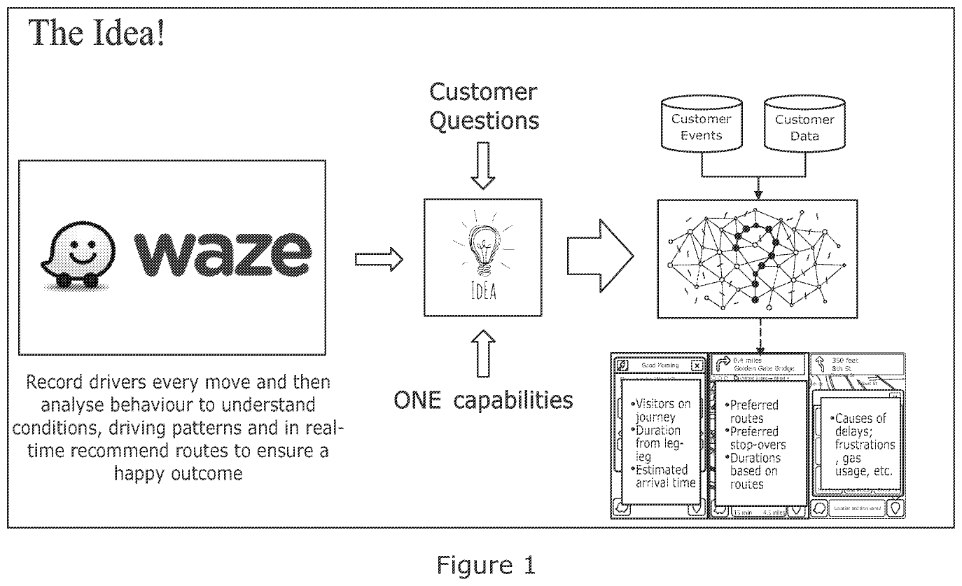

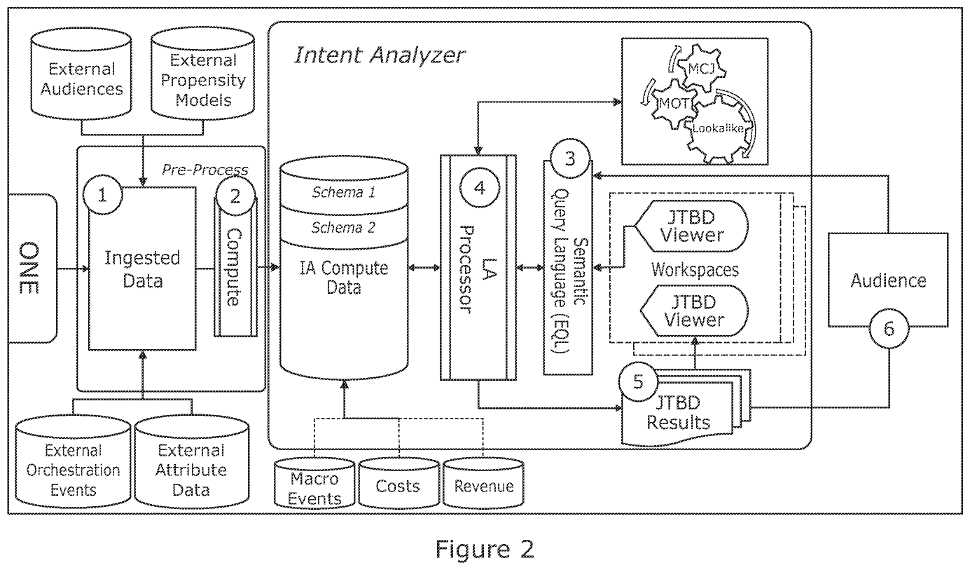

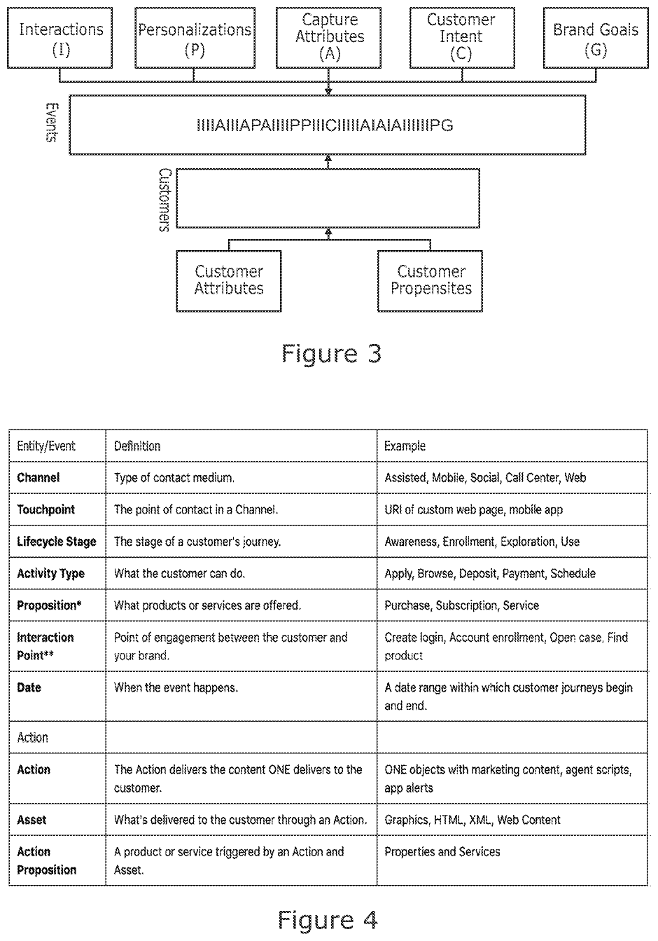

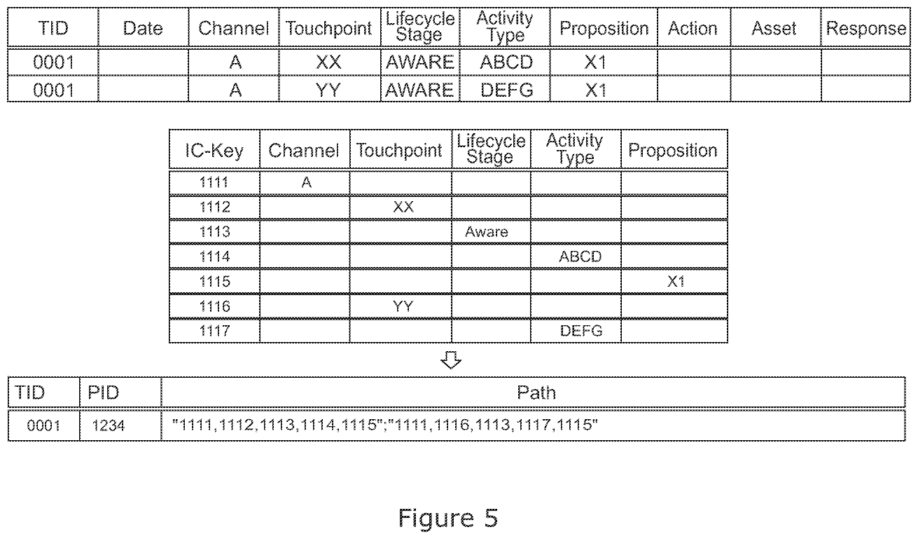

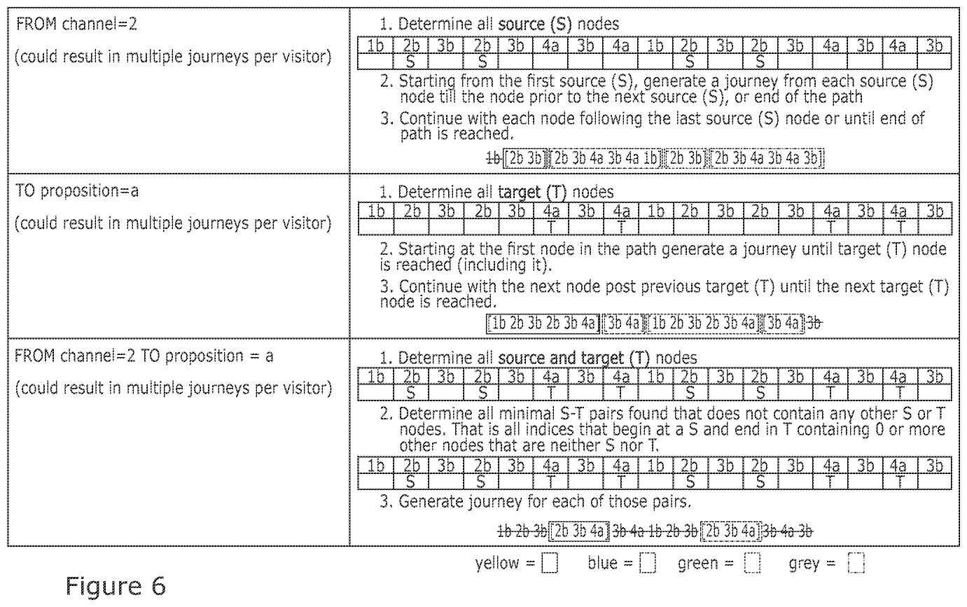

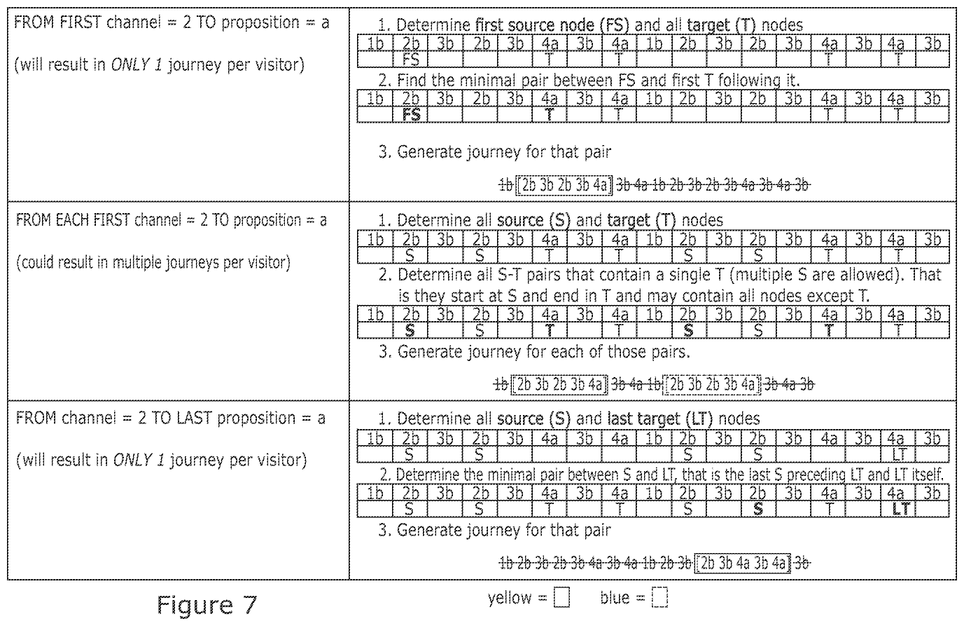

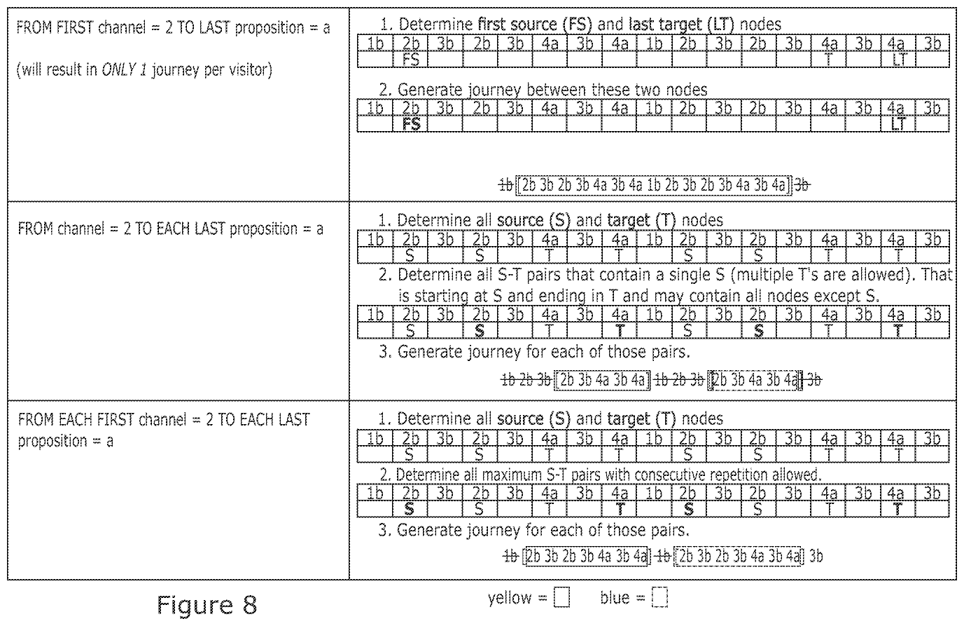

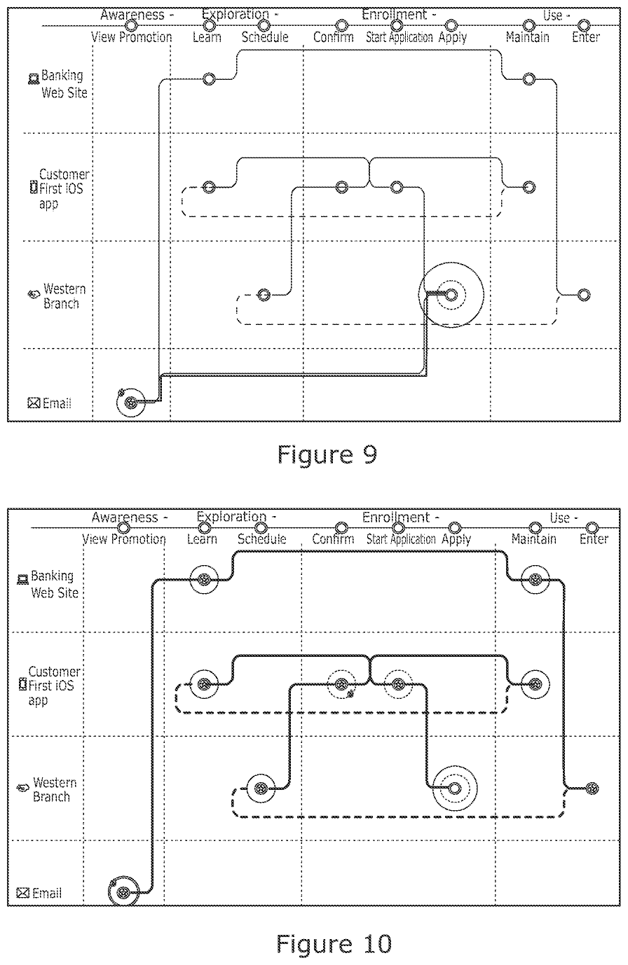

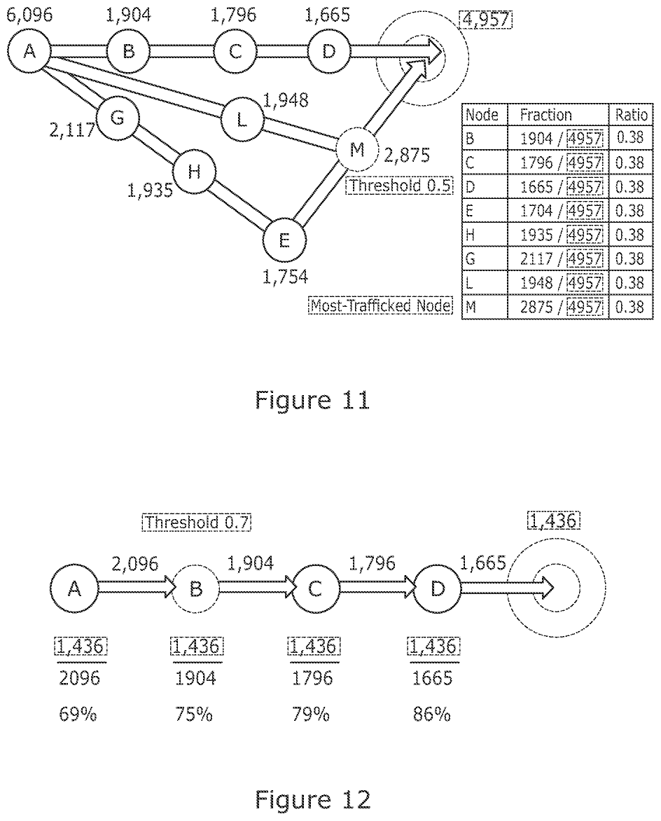

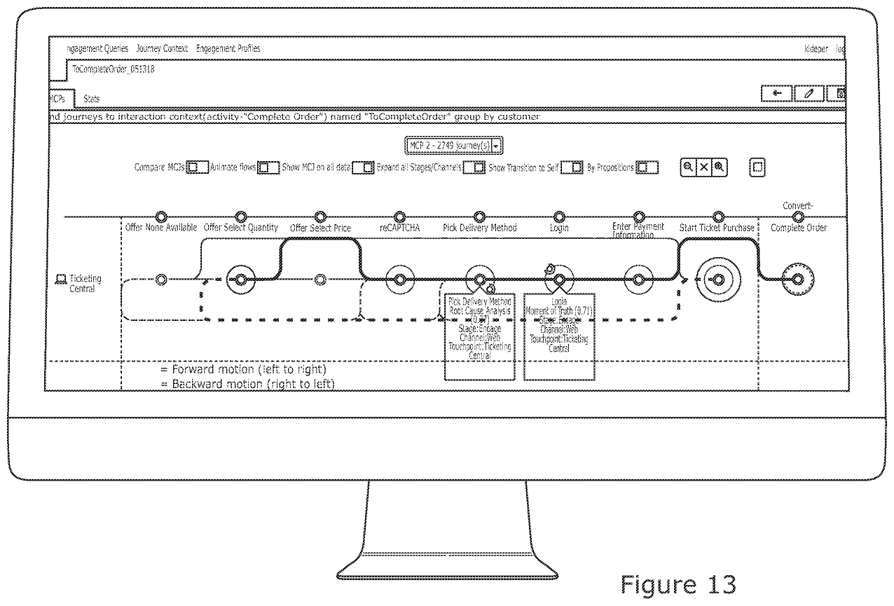

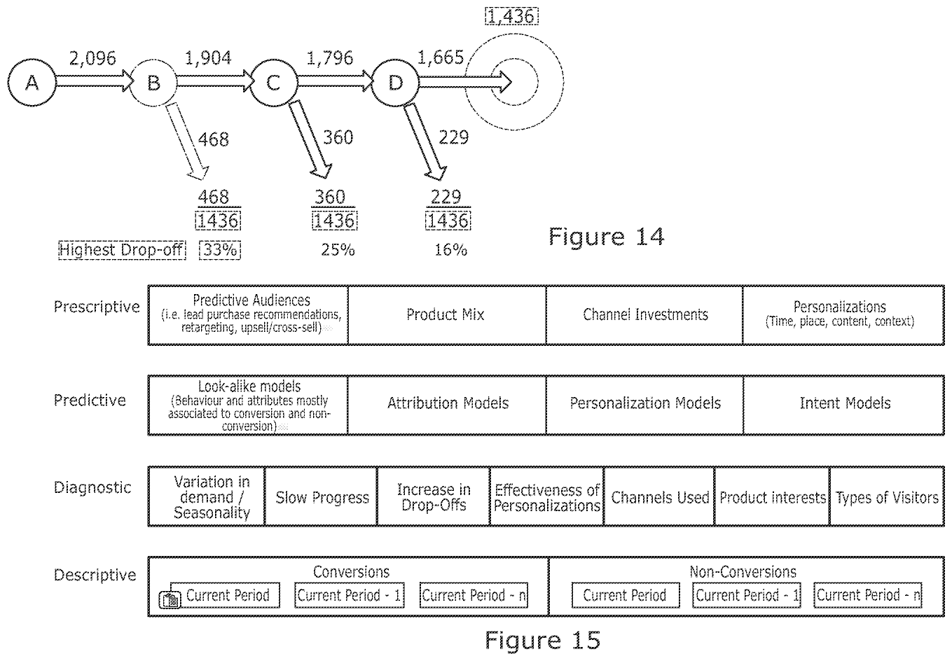

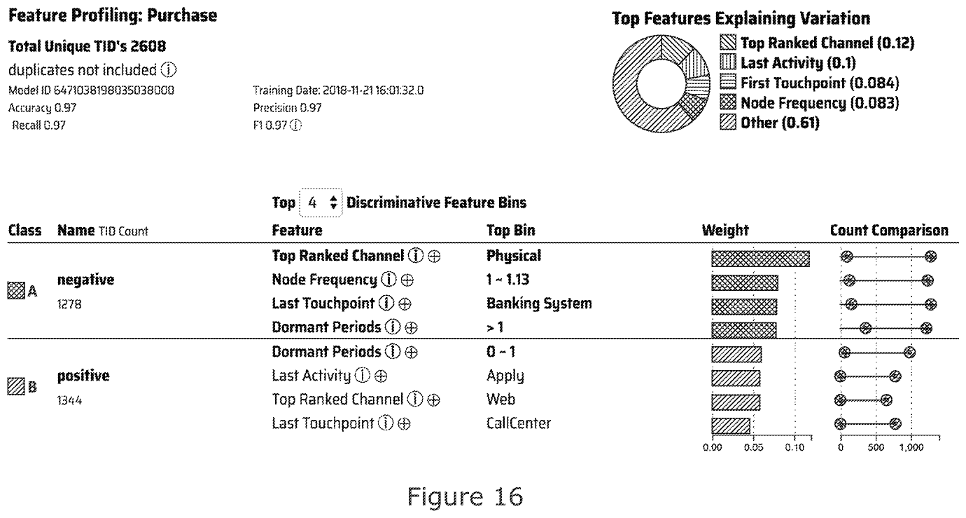

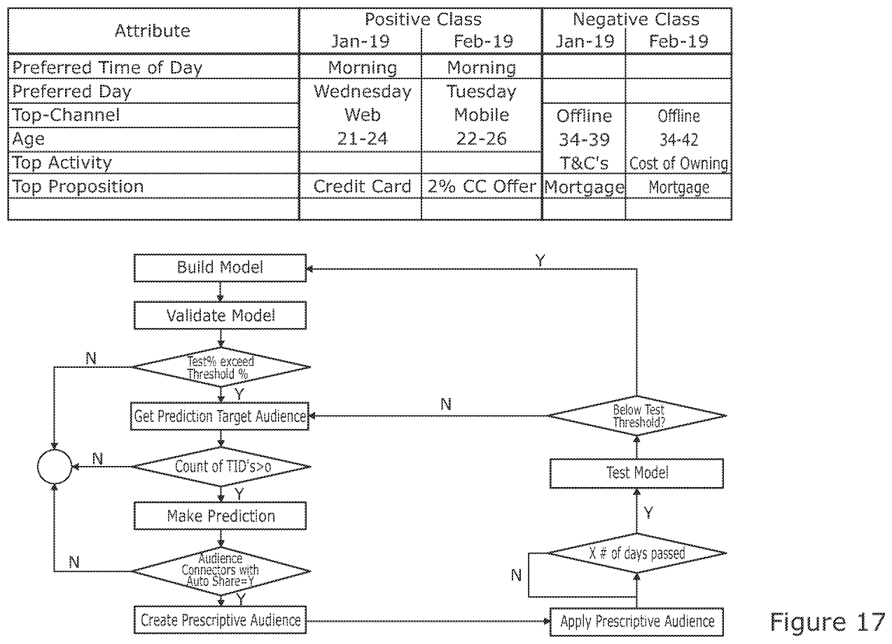

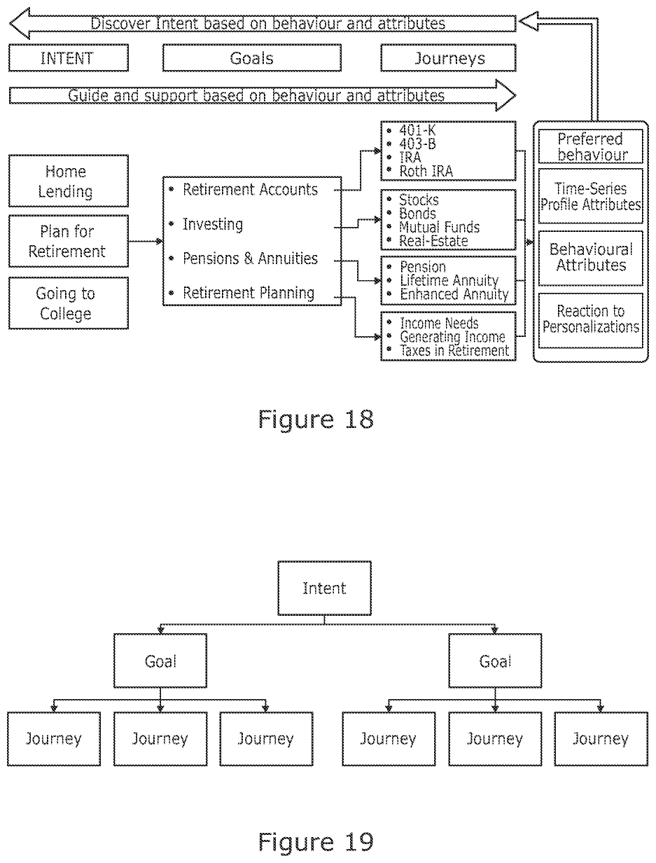

### BACKGROUND

An engagement hub is a platform which “listens” to customers as they engage with a brand across all channels and touchpoints in a process journey from an initial state to an objective state. These listening events are recorded in the database and are combined with additional customer data from CRM systems to make real-time recommendations to help customers achieve their intended objective goals, i.e. acquiring a product or service, reducing the cost of ownership, etc. Although it is quick and relatively easy to realise the value of the data and having the capabilities to provide brands with insights on their customers behavioural preferences is difficult in a readily meaningful way. The difficulty is the variable nature and shear volume of data along with the sporadic variations in that data. Global Positioning system (GPS) like algorithms are known to define physical journeys in terms of the possible different options as different nodes at which the journey can be routed e.g. road junctions, type of road, traffic levels (determined and/or projected) etc. One example of such GPS like algorithm is WAZE. Customer journeys with brand or product can be understood in terms of customers most common interaction preferences and help identify areas where customers seems to get stuck on their way to achieving their goals.

In accordance with aspects of the present invention there is provided a method of predicting intent, the method comprising consolidating a plurality of interactive events; determining a respective alphanumeric identifier for each interactive event or several pre-determinatively similar interactive event, identifying event paths comprising interactive events in the plurality of interactive events to provide a flat sequence of the alphanumeric identifiers consistent with the event path, define one of the alphanumeric identifiers as a From target and define one of the alphanumeric identifiers as a To target; determining all the alphanumeric identifiers between each From target and each To target in the flat sequence of alphanumeric identifiers as ordered as respective sequence journeys and analysing each sequence journey to determine the number of different sequence journeys and assigning at least one sequence journey as proposition as to intent from at least one From target and/or one To target as a probability quotient for a putative interactive event or events represented as alphanumeric identifiers by the method.

The plurality of interactive events may be for a an individual or a group of individuals. The plurality of interactive event may be for a type of individual or entity type.

Each alphanumeric identifier may be assigned as a From target and a To target.

The method may include definition of a Through target and/or a Not Through target required in the flat sequence of alphanumeric identifiers of a respective sequence journey. The respective sequence may require the From target before the Through target and/or the Not Through target. The respective sequence may require the Through target and/or the Not Through target before the To target. The respective sequence may have two or more Through and/or Not Through targets.

The method may include use of a consumer attribute for characterisation of each sequence journey. The consumer attributes may be as described below.

The method may include use of a journey attribute for characterisation of each sequence journey. The journey attributes may be be as described below

The method may include a journey factor to filter the sequence journey. The journey factor may be a statistic as described below.

The method may include a consumer factor to filter the sequence journey. The consumer factor may be a statistic as described below.

Aspects of the present invention also include a system configure to perform the method as described above.

Aspects of the present invention also include a data memory incorporating at least one sequence journey provided by a method or a system as described.

### OVERVIEW

Aspects of the present invention define a method and system which use the process schematically outlined below to maximize the value of the data while keeping things “simple” for a business user.

Initially aspects of the present invention required consolidation and collation of data in the form of interactive events which are presented and provided as part of an operational action or series of actions. This data is ingested to databases as outlined below.

### Ingest Data:

This is the steps where the data from customer solutions are ingested Into the Intent Analyzer environment. The data can come from various sources and there are 2 main types of data:
Customer level data where there is a single record per customer
Event level data where there is a single record for every interaction the brand had with the customer, either initiated by the customer or initiated by the brand.

### 1. Compute

In this step the ingested data is prepared for query processing by firstly flatten all events into a single path and then assigning ranges to propositions.

### Flattening Events:

a. Each of the “interaction Elements” gets assigned a unique alphanumeric identifier. An Interaction consists of the following elements:

| Entity/Event | Definition | Example |
|---|---|---|
| Channel | Type of contact medium. | Assisted, Mobile, Social, Call Center, Web |
| Touchpoint | The point of contact in a Channel. | URI of custom web page, mobile app |
| Lifecycle Stage | The stage of a customer's journey. | Awareness, Enrollment, Exploration, Use |
| Activity Type | What the customer can do. | Apply, Browse, Deposit, Payment, Schedule |
| Proposition* | What products or services are offered. | Purchase, Subscription, Service |
| Interaction | Point of engagement between | Create login, Account enrollment, |
| Point** | the customer and your brand. | Open case, Find product |
| Date | When the event happens. | A date range within which customer |
| | | journeys begin and end. |
| Action | | |
| Action | The Action delivers the content | ONE objects with marketing |
| | ONE delivers to the customer. | content, agent scripts, app alerts |
| Asset | What's delivered to the customer through an Action. | Graphics, HTML, XML, Web Content |
| Action | A product or service triggered | Properties and Services |
| Proposition | by an Action and Asset. | |

The system processes each event and creates a unique alphanumeric identifier for every interaction element and uses those to create a matrix of all events as a single row for the customer.

b. Assign proposition ranges to allow for role up propositions in a hierarchy:

The input data contains proposition strings delimited by ‘/’, similar to a directory structure (/Bank/CreditCards/SiiverCard).

### Example:

‘/Bank/CreditCard/Silver’

‘/Bank/CreditCard/Gold’

‘/Bank/CreditCard/Platinum’

‘/Bank/Mortgage’

‘/Bank’

‘/Bank/Personal/Mortgage’

We read in all the propositions from the ‘dim-propositions’ input file and build a tree structure. At the same time, we also inject any intermediate entries that were not found in the data directly, such as ‘/’, /Bank/CreditCard’ and ‘/Bank/Personal’. This tree is then used to determine the maximum depth and width of the hierarchy. From these we determine the ranges of the hierarchy.

### Example:

‘/Bank/CreditCard/Silver’=21

‘/Bank/CreditCard/Gold’=22
‘/Bank/CreditCard/Piatinum’=23
Thus
‘/Bank/CreditCard’=20 with maxId=23
With the proposition ID plus the maximum id for that level we can easily filter to contain all propositions under that level. For example if we want all CreditCard propositions we specify the proposition id of 20, and internally it knows the maximum id for that item (23) and will then filter to propositions of ids: 20, 21, 22, and 23

c. Calculate behavioural attributes:
A user could request that behavioural features gets calculated. These attributes use time based data to identify customer behavioural preferences. These attributes are available as customer level filters but they are also available during the Feature discovery within the Machine Learning section of IA. We currently calculate about 65 of these.

### Example of These Attributes:

Calendar Preferences:
   Time-of-Day: What time of day does a customer seems to engage
   Day-of-Week: Preferred day of the week the user engages
Channel Preferences:
   Preferred-Channel
   Preferred-Device

### 2. Engagement Query Language (EQL)

There is no value in putting all this data together if there is no way for a brand to have easy access to if there is no way generate insights which will allow a brand to understand their customers behaviour and change the way they engage. We designed EQL in such a way that the business user can make sense of customer behaviour without the need to understand the way the data is gathered and stored. The data itself is anonymous, it is a very business user orientated version of EQL but the focus of the language is on interpreting the data through the fens of a customer journey versus looking at records in isolation (which is what EQL does).

The language constructs are partitioned into 4 sections:
Customer level:
   Select customers based on a set of individual attributes, i.e. Age, Country of residence, etc.
   Select customers based on a customer level view of events, i.e. Customer has had more than 30 interactions during a certain period of time
Journey level:
   Journey level filters act only on the flattened customer path. Journey level filters also act on either the individual event level or on a set of events.
   Individual event filters:
      There are 3 constructs here:
         FROM target: Identifies which event Is defined as the start of a journey
         TO target: identifies which event is defined as the end of a journey
         THROUGH target: Identifies those events which has to exist/not exist between a FROM and TO node (if they are specified)
   Journey statistical filters:
      This filter allows a user to interrogate events within the context of each journey identified through the individual event filters, i.e. Where Count of Interactions >10.

The list of query constructs is contained in an addendum at the end of this document.

### 3. IA Processor

The role of the IA processor is to take the submitted query and apply it to the data and provide the user with a result.

The defined query gets processed via a sequence of steps which are:
1. Apply customer level individual customer filters
2. Apply customer level statistical filters
3. Use the FROM target and TO target journey filters to cut/split a customer full path into 1 or more journeys.
4. Apply the THROUGH/NOT THROUGH target filters to those cut journeys
5. Apply journey level statistical filters
6. Apply customer level filter that correlates to the number of journeys to be returned, i.e. first, last, etc.
7. Calculate customer and journey level statistics

There are also a set of tasks that will be performed if the user requested those to be calculated. They are:
Calculate Most Common Journeys (MCJ) and Most Common Routes (MCR)
Calculate Conversion Attribution and Root Causes
Calculate Most Valuable Optimization (MVO) which contains a list of Actions and the contribution they have to conversion.
Provide a visitor list consisting of those customers in the result set.

The first 2 will be address in a separate section.

Logic to cut and split a customer's path into separate sequence journeys: The following query constructs are allowed and the way they are combined will determine how the sequence journeys will be split/cut into separate journeys;
FROM (. . .) TO (. . .)
FROM EACH FIRST (. . .) TO (. . .)->ALLOWED
FROM (. . .) TO EACH LAST (. . .)->ALLOWED
FROM FIRST (. . .) TO (. . .)->ALLOWED
FROM (. . .) TO LAST (. . .)->ALLOWED
FROM FIRST (. . .) TO LAST (. . .)->ALLOWED
FROM EACH FIRST (. . .) TO EACH LAST (. . .)->ALLOWED

The following 2 options are not valid as FROM EACH (resulting in possibly multiple journeys) compete with TO LAST resulting in one journey.
FROM EACH FIRST (. . .) TO LAST (. . .)
FROM FIRST (. . .) TO EACH LAST (. . .)

There is also an advanced query construct available to find an alignment between interaction elements in the FROM target and TO target filter. These constructs are # FROM and # TO:
# FROM: This value can be used in a TO filter, i.e. TO Proposition=# FROM will make sure that the FROM and TO propositions are the same.
# TO: This value can be used in Interaction elements of a FROM statement, i.e. FROM Touchpoint=% TO; Activity Type=“View Product Costs”. The system will find an event that satisfies the TO filter and will then find an event prior to it using the TO events Touchpoint.

Both # FROM and # TO can also be used in a THROUGH and/or a NOT THROUGH target filter.

### 5. Query Result

The query results contain 3 primary sets of data:
Query statistics, i.e. customer count, Journey count, average duration of journeys, etc.
Journey Grid which contains the matrix of all node-node transitions of the customers in the result set.
Information related to the MCJ, MCR, MOT and MVO's

The query result also contains a list of customer ID's if the user requested those to be saved.

### 6. Audience Creation

A user can use the list of customers included in a result set to publish an Audience going out to an external customer-oriented system. There are 4 levels of Audiences and all of them are created In the context of journeys.

### Basic Audience:

This is an audience created from the full result set.

### Advanced Audience:

This is an audience created by the user using insights created by the advanced algorithms (described later in this document).
MCJ based: This will publish all the customers within a specific MCJ
MCR based: This will publish all the customers within a specific most common route
MOT/RCA node: This will publish all those customers that went through a specific MOT/RCA node

### Predictive Audience:

This is an audience created using the ML components and this audience contains a list of customers along with their propensity to either purchase a product, complete a journey, etc.

### Prescriptive Audience:

These audience are also created using the ML components of IA and it contains a list of customers along with a specific prescription of Actions to be presented to those customers.

### Advanced Algorithms

### Most Common Sequence Journey and Most Common Routes

The intent of these algorithms are to help identify commonality in behaviour of customers included in a result set. There are 2 steps:
1. Find most cost common starting point (From target) and ending point (To target) combinations for those journeys in the result set. This is called MCJ. This provides the context for the next step.
2. Find most common sequence of activities between the starting (From target) and ending nodes (To target) of each Most Common Journey

The system also calculates specific statistics for the node-to-node transitions within a common route. Some of these are:
Number of visitors that transitioned between the nodes (From target and To target)
The average time between the node transitions
Standard deviation calculation of duration between nodes

### Conversion Probabilities

The purpose of the Conversion Probabilities calculation is to identify how much value gets attributed to each node (From target or To target or Through/Not Through target) in support of a conversion activity. A conversion activity is represented by a TO filter and one is required to enable the calculation. There are 2 types of calculations:
Global where each node gets calculate independently of any other activities, and
Path-based where only nodes that are on a most common routes and considered

### Global-Based:

Intent Analyzer calculates, for All Journeys, the single most frequently visited node of all the journeys that reach a specified target node. The illustrated example shows Most Common Journeys and the single node with the highest probability of conversion. That is the node with the highest number of customer journeys that reach the target node (From, To or Thorough).

Node M has most customer journeys above a specified threshold that end with the target node.

### As an Algorithm:

1. Take all journeys to the target TO node defined in the query.
2. Count all journeys that go to the target.
3. For each node: Divide each node count by the target count.
4. Find the node with the highest ratio.

Node M has the highest conversion probability for all customers.

### Path-Based Conversion Probability

The objective is to calculate the first node of all routes with conversion above a specified threshold that ends with the target (TO) node.

### Example

Intent Analyzer calculates for one Most Common Journey the first node with a ratio of journeys to the specified target node that exceeds a threshold you set. The illustrated example explains the calculation method in more detail. It shows the method by which the Conversion Probability of a journey's nodes is calculated.

Node B is the first node that has a ratio of customer journeys that reach the target above the threshold.

There were 1,436 customer journeys that reached the target node. Working backwards to each previous node, we find the ratio of customer journeys that reach the target decreases until reaching a node (A) below the threshold. Node B, therefore, has the highest Conversion Probability. The journey count is increasing as you work backward, which shows that the “further away” customers are from the target, the lower the likelihood of reaching it because of drop-off.

### As an Algorithm:

1. Count the number of customer journeys that end with the target TO node.
2. For each node in the journey before the target (Nodes D, C, B, E):
a. Count the number of customer journeys through this node regardless of whether or not they reached the target.
b. Divide the target count (from Step 1) by each node count (from Step 2a).
3. Repeat until the ratio (from Step 2b) is less than the specified threshold (Node A)

Node B is the first node above the threshold and has the highest Conversion Probability.

### Dropoff Probability Analysis

Drop-off Probability identifies negative moments in Customer Journeys that translate into customers’ not being able to satisfy their goals. This a key metric in the analysis of customer behavior. For example, it can reveal if there is an interaction that discourages a particular demographic from completing a purchase.

The objective is to calculate which node has the steepest decrease in customer journeys relative to the previous node. [A customer journey is considered to have ended if the customer journey time-outs after 24 hours of inactivity]

### Example

The calculation is made for one Most Common Journey, regardless of alternate routes. The illustrated example shows the calculation method. Each node is paired with the previous one, and the differences are calculated. The node with the largest decrease has the highest Drop-off Probability—meaning the most customer journeys are likely to end at this node.

Node B has the highest ratio of customers dropping off from the journey to the target node.

### Most Valuable Optimization

The purpose of this algorithm is to identify how much a personalization (Action) contributes towards a journey conversion. There are multiple versions of this algorithm where each iteration adds more complexity into the calculation.
I. Value of each Action regardless of where and when it was delivered in the journey
II. Value based on location of Action in journey, i.e. first, last (before conversion), first in each lifecycle stage, etc.
III. Value of an Action depending on the channel/touchpoint it was delivered
IV. Value of an Action within a Lifecycle Stage to help move a customer into a next stage (rather than to the ultimate conversion activity)
V. Most valuable sequence of Actions
VI. Most Value Action clusters, meaning what group of customers (cluster) seems to have a correlation to the success of the Action in support of conversion.

### Machine Learning

There are two aspects namely:
1. Using Classification Modeling for diagnostics, and
2. Straight Through Processing through automation of the full modeling lifecycle

### Using Classification Models for Diagnostics

The purpose of a classification model is to identify a set of attributes (features) within each model class that differentiates the classes from each other

Below is an example of the representation of such a model

Models are generally created to make predictions over an “unseen” audience to determine their propensity to sit within one of the modelling classes. We have however realized there is value in using models as a method to perform diagnostics across multiple sets of data, i.e. compare the attributes related to a positive class as calculated in January to attributes for the same class a month later.

### Straight Through Modeling Process

Data is used to train models and those models are then used to make predictions and eventually prescriptions. We designed a method whereby the full process is automated to ensure that predictions and prescriptions continue to delivered highly accurate predictions and prescriptions of intent.

### Intent Based Decisioning

The purpose of intent based decisioning is that it continuously provides recommendations (via Actions) for customers to help them along their journeys. Customers behaviour across a range of products and services provided by the brand provide deep insights as to the goals and eventually the intent of the customer, it is important that brands understand their customers intent and do whatever is needed to help customers achieve that intent rather than viewing proposition interest in silo's and getting sucked into making recommendations that might deliver short term value to the brand but delays the customer from achieving their longer term intended outcome.

Our approach to implementing this capability is to use the combination of classification and reinforcement learning where classification is used to first identify the most relevant intent based on customer attributes and interests, then use classification for goals available to achieve the intent and find the most relevant goal and then for the identified goal identify if the customer is on any of the journeys related to that goal. If the customer is not on any of the journeys, then a journey will be selected using classification. If the customer is on any of those journeys, then we need to find the journey that has progressed the most and use reinforcement learning to find the most relevant next Activity for that journey. The next-best-Activity will then be used to find an Action which can convey the content represented by the Activity Type.

The user however has the option to override the “intent” process by identifying to first progress journeys that are at least in a specific journey stage, i.e. Knowledge. The customer could however be in multiple journeys which are all at least in the identified stage and then the journey that has progressed the furthest will be used. Reinforcement learning will then be used to identify the next-best-activity and eventually the Action.

### Creating an Intent Hierarchy

A brand needs to create an intent hierarchy to establish the relationships between the various elements. Each of the objects in the hierarchy gets an associated query which will identify when a customer has either achieved the journey, the goal or the intent.

### Training the Classification Model

This is an iterative step with the purpose of calculating a customers propensity for each journey, then roll up the journeys to their associated goal and calculate the customers propensity for the goal and then finally roll up to calculate their propensity for each “intent” as specified by the brand. These queries are used in classification.

### Other Possible Options

Creating Journey Maps from Journey visualization
Dynamic Actions

The above methods and systems operated in accordance with such methods provide processes whereby data is prepared then use of that data is optimised for journey orchestration and journey algorithms. Journey orchestration is optimised for prevailing circumstances so the user profile (financial status, likes, dis-likes, previous behaviour etc.) The user profile may specific to a particular user or more normally a categorisation at a pre-determined level so at a typical very broad generic level so male or female but normally a level of pariicularisation so male, British, XYZ socio-economic group, made an enquire about a credit card in the last 3 months etc. The data preparation can then be used for journey orchestration and/or for journey algorithms in a more convenient manner.
Use past behavior of customers that achieved their goals to predict what sequence and combination of customer activities and brand personalizations will result in the highest probability that a customer that begins the journey will achieve the goal in due time.
The focus of JBO is ALWAYS the Journey as a whole to recommendations made using the JBO functionality always consider the full journey context and even the cross-journey context
This is in contrast to most other “decisioning” solutions that is only focus on the “next-best” personalization.

With journey algorithms
An algorithm is defined as a process or set of rules to be followed in calculations or other problem-solving operations, especially by a computer.
The algorithms that are part of this patent are:
All journey based, meaning that it acts on all data that are already formatted into journeys,
Focused on identifying patterns found in customers behavior as they interaction across available channels overtime.
Formatting the patterns into actionable components that provide input Into journey orchestration.

With journey orchestration it will be understood that the key algorithms used in journey based orchestration are:
MCJ (Most Common Journeys)—what is the most common starting point for a journey which then results in a journey completion or incompletion at a common place.
MCR (Most Common Routes)—what is the most common interactions, transition points, forward and backward movements between the beginning and ending nodes of each MCJ.
MOT (Moments of Truth)—where in the journey has the customer reached a stage that they are committed to complete the journey
RCA (Rootcause)—where in the journey do most customers loose interest in completing the journey
MVO (Most Valuable Orchestration)—what is the most effective set of personalizations provided to customers which resulted in journey completions.

### Addendum

### EQL Query Constructs

discover [nth] [FROM/THROUGH/TO decomposition] [Journey Level Filters] [Customer Level Filters]

### Journey Decomposition

FROM/TO are cutting fillers in that they lake a full customer path and cut it into 1 or more journeys based on the requested attributes. Both are not required but only one Instance of each can be specified, and the order is strict (i.e. FROM must come before TO). The THROUGH is applied after the journey is determined to further determine the validity of the journey. There are also a number of options that can be applied to FROM/TO that alters the behaviour of how the cut is performed but in general will take the innermost pair it finds.

An example for a given path
1b 2b 3b 2b 3b 4a 3b 4a 1b 2b 3b 2b 3b 4a 3b 4a 3b

Where the # represents the channel and the letter represents the proposition, the following possible journeys can be generated (highlighted sequence subsets in square brackets are the matching journeys):

| | |
|---|---|
| FROM c = 2 | 1b [2b 3b] [2b 3b 4a 3b 4a 1b] [2b 3b] [2b 3b 4a 3b 4a 3b] |
| TO p = a | [1b 2b 3b 2b 3b 4a] [3b 4a] [1b 2b 3b 2b 3b 4a] [3b 4a] 3b |
| FROM c = 2 TO p = a | 1b 2b 3b [2b 3b 4a] 3b 4a 1b 2b 3b [2b 3b 4a] 3b 4a 3b |
| FROM FIRST c = 2 TO p = a | 1b [2b 3b 2b 3b 4a] 3b 4a 1b 2b 3b 2b 3b 4a 3b 4a 3b |
| FROM EACH FIRST c = 2 TO p = a | 1b [2b 3b 2b 3b 4a] 3b 4a 1b [2b 3b 2b 3b 4a] 3b 4a 3b |
| FROM EACH FIRST p = a TO c = 4, | 1b 2b {3a 2b 3b [4a} 3b 4a] 1b 2b 3b 2b 3b [4a 3b 4a] 3b |
| p = a matching on (p) | |
| FROM c = 2 TO LAST p = a | 1b 2b 3b 2b 3b 4a 3b 4a 1b 2b 3b [2b 3b 4a 3b 4a] 3b |
| FROM FIRST c = 2 TO LAST p = a | 1b [2b 3b 2b 3b 4a 3b 4a 1b 2b 3b 2b 3b 4a 3b 4a] 3b |
| FROM EACH FIRST c = 2 TO LAST p = a | 1b 2b 3b 2b 3b 4a 3b 4a 1b [2b 3b 2b 3b 4a 3b 4a] 3b |
| FROM c = 2 TO EACH LAST p = a | 1b 2b 3b [2b 3b 4a 3b 4a] 1b 2b 3b [2b 3b 4a 3b 4a] 3b |
| FROM FIRST c = 2 TO EACH LAST p = a | 1b [2b 3b 2b 3b 4a 3b 4a] 1b 2b 3b 2b 3b 4a 3b 4a 3b |
| FROM EACH FIRST c = 2 TO EACH LAST p = a | 1b [2b 3b 2b 3b 4a 3b 4a] 1b [2b 3b 2b 3b 4a 3b 4a] 3b |
| (future) FROM c = 2 TO p = *FROM* | Ability to reference attributes from the corresponding |
| Possible nomenclature: | FROM/TO |
| matching on interaction(. . .):action(. . .) | |
| boundary matching on interaction(. . .):action(. . .) | |
| matching endpoints on interaction(. . .):action(. . .) | |
| extremity-matching on interaction(. . .):action(. . .) | |
| matching extremities on interaction(. . .):action(. . .) | |

*NOTE:
The above is a simple example of the general decomposition logic. For more in depth tests and edge cases please refer to the Unit Tests provided within the code.

### Combining Nodes

During the decomposition step, adjacent nodes are matched on all criteria, if matching, they are combined for the purpose of the decomposition to reduce the noise in paths (e.g. “a1 a1 a1”→“a1”). Following this, they are all considered to be a possible source, target or both, and this combination can result in unexpected results. Thus, adjacent nodes that differ on non-specified attributes can become spilt and generate single node journeys where a user might have though they would not be.

### Through and Not Through

This filter ensures that the specified through nodes are traversed within the journey. This filter is applied after the decomposition step but may also be used without the FROM/TO clauses. This construct does support a full Boolean tree as well as negation and nesting of the logical elements is performed using parentheses. The following lists a few examples:

| | |
|---|---|
| THROUGH c = 3 | [1b 2b 3b 2b 3b 4a 3b 4a 1b 2b 3b 2b 3b 4a 3b 4a 3b] |
| FROM c = 2 THROUGH c = 3 TO p = a | 1b 2b 3b [2b 3b 4a] 3b 4a 1b 2b 3b [2b 3b 4a] 3b 4a 3b |
| FROM c = 2 THROUGH c = 3 and c = 4 TO p = x | 1b 2b 3b [2b 3b 4a 3x] 4a 1b 2b 3b 2b 3b 4a 3b 4a 3b |
| FROM c = 2 THROUGH not(p = b) TO p = a | 1b 2b 3b 2b 3b 4a 3b 4a 1b 2b 3b 2b 3b 4a 3b 4a 3b |
| FROM c = 2 THROUGH c = 3 or c = 4 TO p = a | 1b 2b 3b [2b 3b 4a] 3b 4a 1b 2b 3b [2b 3b 4a] 3b 4a 3b |
| FROM c = 2 THROUGH c = 3 and (p = a or p = b) TO p = x | 1b 2b 3b [2b 3b 4x] 4a 1b 2b 3b [2b 3b 4a 3b 4x] 3b |

THROUGH also has the special property in that order is preserved i.e. THROUGH(ab) will only keep paths that went through a followed by b (gaps are allowed i.e. xazby is allowed), but a path that is xbay is discarded. NOT THROUGH is always considered as a containment check, and no order is checked in this case, if one node in the NOT case is found the path will be discarded as it is considered an ANY check.

### Propositions Case

Propositions contain an internal hierarchy structure which is preserved and used. When a proposition is used, by default all matching propositions and its children are considered valid. This means that a query such as FROM (propositiori=“Bank/CreditCard”) would consider all events that go through /Bank/CreditCard, /Bank/CreditCard/BlackCard, /Bank/CreditCard/Travel/PointsCard as valid possible decomposition locations. Note that, care should be used when presenting users options and that consistency is needed and not use a trailing ‘/’.

### Journey Statistic Filters

Journey statistic are properties of each journey, such as duration, skips, etc (see filters below). Journey statistic filters are applied to the found journeys after the decomposition step is completed. This validates the individual journeys to all other secondary criteria as required by the filter. Multiple journey filters can be applied together using a full Boolean tree. Typically journey level filters are also applicable at the full customer path level and are identified by the ‘WHERE’ clause after the journey decomposition section.

### Customer Statistic Filters

Customer statistic filters are properties of the customer (i.e. TiD), such as identified or anonymous customers. Customer filters perform their filtering on the full customer path or other customer level attribute(s). These filters are considered pre-filters and always happen before the journey decomposition or journey filters are applied with one exception being (count of journeys>x). Customer filters have internally a number of subgroups where specific, filters are applied and have an inherent order to them as well, the order is ‘for’, ‘having’, ‘using’, and ‘excluding’.

### Dates

Dates are always problematic, as such the grammar makes some basic assumptions and attempts to restrict the date entries as much as possible while still maintaining the appropriate level of flexibility. The following are items specifically dealing with dates:
Date ranges require two values. If either end of the range is not used (meaning from the beginning of or to the end of time) then either the value can be left blank or the keyword “whenever” can be used. Ex. Date (,2019-01-01 00:00) and date (whenever, 2019-01 -01 00:00) are synonymous and mean any date up to Jan. 1, 2019. Internally “whenever” is represented as 1000 years before or after “now”.
When date is used within the interaction or action constructs it is simply date (a, b), i.e. it no longer supports the assignment ‘=’ parameter.
Date ranges are closed on the left and open on the right, i.e. [start, end)
Dates must be specified in the following format ‘YYY-MM-DD HH:MM’. (And not ‘YYYY-DD-MM’.)
Dates must be specified to the ‘minute’ level so as to allow for explicit determination of what the user is expecting
The grammar does not deal with timestamps of any sort at this time, it is assumed that the date provided matches the time zones in the data as well as format.

### Misc

Some modifications were made for the purpose of performance, complexity or restrictions in ANTLR.
The attributes of an interaction node must be specified in order: channel, touchpoint, interaction, stage, activity, proposition, date, device OS, and lastly device Type. All are optional.
The attributes of an action node must be specified in order: channel, touchpoint, interaction, proposition, action, response, asset, optimization, device OS, and lastly device Type. All are optional.

### Modifications

The grammar is continually evolving, this list provides the discussed modifications to the current state of the grammar:
[symbol] [symbol] (visitors instead of customers?)

### Filters Overview

### Decomposition Filters

Each may be specified at most once.
They must be specified in order, ‘from’, then ‘through’, and lastly ‘to’.
   Using/Excluding Filters
   Having Filters
   For/Where Filters

1. A method of predicting intent, the method comprising
consolidating a plurality of interactive events;
determining a respective alphanumeric identifier for each interactive event or several pre-determinatively similar interactive events, identifying event paths comprising interactive events in the plurality of interactive events to provide a flat sequence of the alphanumeric identifiers consistent with the event path, define one of the alphanumeric identifiers as a From target and define one of the alphanumeric identifiers as a To target;
determining all the alphanumeric identifiers between each From target and each To target in the flat sequence of alphanumeric identifiers as ordered as respective sequence journeys and analysing each sequence journey to determine the number of different sequence journeys and assigning at least one sequence journey as proposition as to intent from at least one From target and/or one To target as a probability quotient for a putative interactive event or events represented as alphanumeric identifiers by the method.

2. A method as claimed in claim 1 wherein the plurality of interactive events is for a an individual or a group of individuals.

3. A method as claimed in claim 1 wherein the plurality of interactive events is for a type of individual or entity type.

4. A method as claimed in claim 1 wherein each alphanumeric identifier may be assigned as a From target and a To target.

5. A method as claimed in claim 1 wherein the method includes definition of a Through target and/or a Not Through target required in the flat sequence of alphanumeric identifiers of a respective sequence journey.

6. A method as claimed in claim 1 wherein the respective sequence require the From target before the Through target and/or the Not Through target.

7. A method as claimed in claim 1 wherein the respective sequence require the Through target and/or the Not Through target before the To target.

8. A method as claimed in claim 7 wherein the respective sequence have two or more Through and/or Not Through targets.

9. A method as claimed in claim 1 wherein the method includes use of a consumer attribute for characterisation of each sequence journey.

10. A method as claimed in claim 9 wherein the consumer attributes include ‘for’, ‘having’, ‘using’, and ‘excluding’.

11. A method as claimed in claim 1 wherein the method includes use of a journey attribute for characterisation of each sequence journey.

12. A method as claimed in claim 11 wherein the journey attributes include duration and skips.

13. A method as claimed in claim 1 wherein the method includes a journey factor to filter the sequence journey.

14. A method as claimed in claim 13 wherein the journey factor is a statistic.

15. A method as claimed in claim 1 wherein the method includes a consumer factor to filter the sequence journey.

16. A method as claimed in claim 15 wherein the consumer is a statistic factor.

17. A method as claimed in claim 1 wherein the method includes a or a plurality of journey orchestrations represented by the alphanumeric identifiers, each journey orchestration comprising a respective algorithm used in the journey orchestration to facilitate transfer along the journey will result in the highest probability that a user that begins the journey will achieved the TO target goal in or within a predetermined manner.

18. A method as claimed in claim 17 wherein the predetermined manner is a time period.

19. A method as claimed in claim 17 wherein the predetermined manner is provided by an algorithm to provide one or more of the following:
MCJ (Most Common Journeys)—what is the most common starting point for a journey which then results in a journey completion or incompletion at a common place;
MCR (Most Common Routes)—what is the most common interactions, transition points, forward and backward movements between the beginning and ending nodes of each MCJ;
MOT (Moments of Truth)—where in the journey has the customer reached a stage that they are committed to complete the journey;
RCA (Rootcause)—where in the journey do most customers loose interest in completing the journey; and
MVO (Most Valuable Orchestration)—what is the most effective set of personalizations provided to customers which resulted in journey completions.

20. A method as claimed in claim 1 wherein the method includes a or a plurality of journey orchestrations in the form of the alphanumeric identifiers such that the journey is defined as a process or set of rules to be followed in calculations or other problem-solving operations, especially by a computer whereby the method acts on all data that are already formatted into journeys by the method so identifying patterns found in user behavior as they interaction across available channels over time and formatting the patterns into actionable components that provide input into journey orchestration.

21. A system including a processor arranged to operate the method as claimed in claim 1 upon a data base and/or a stream of data in a consumer interaction.

22. A storage device including a database configured using a method as claimed in claim 21.
